(19) United States
(12) Patent Application Publication
(10) Pub. No.: US 2013/0016520 A1
(43) Pub. Date: Jan. 17, 2013

(54) COMPACT LIGHT HOMOGENIZER

(71) Applicants: Christopher Jacob Reimer, Midland (CA); Michael David Thorpe, Penetanguishene (CA)

(72) Inventors: Christopher Jacob Reimer, Midland (CA); Michael David Thorpe, Penetanguishene (CA)

(73) Assignee: RAYTHEON COMPANY, Waltham, MA (US)

(21) Appl. No.: 13/545,843

(22) Filed: Jul. 10, 2012

Related U.S. Application Data
(60) Provisional application No. 61/506,451, filed on Jul. 11, 2011.

(51) Int. Cl. F21V 13/02

(52) U.S. Cl. 362/558

(57) ABSTRACT

Provided are assemblies and processes for achieving desirable homogenization and mixing of one or more light sources. The assemblies include the use of diffusers and light pipes in a particular configuration that allows very good homogenization performance while reducing the requisite length of light pipe. In particular, a length of a light-pipe homogenizer can be substantially reduced by diffusing the light after it has been partially pre-mixed by a light pipe. Additional mixing can take place after diffusion. For example, a diffuser can be positioned within a light pipe or sandwiched between two light pipes. In some embodiments, the diffuser is placed at a point along a light pipe where the light from each source or each portion of a single source substantially covers the diffuser approximately equally. Consequently, a rate of homogenization can be increased, thereby reducing the required length of the complete homogenization system.

### RELATED APPLICATIONS

The present application claims priority to U.S. Provisional Patent Application No. 61/506,451, filed Jul. 11, 2011, which is incorporated in its entirety herein by reference.

### TECHNICAL FIELD

Various embodiments are described herein relating generally to the field of illumination, and more particularly to produce substantially uniform illumination from at least one light source.

### BACKGROUND

Light sources, such as light emitting diodes (LEDs), incandescent lamps and the like, generally require light mixing, or homogenization to produce a substantially uniform illumination. Such uniform illumination is beneficial in various applications, such as image projectors (e.g., motion picture) or microscope illuminators. Methods for accomplishing uniform illumination have included imaging relatively uniform sources, or using illumination optics such as Köehler systems. To accomplish similar results with highly non-uniform sources, such as LEDs, or worse, arrays of LEDs, high performance homogenizers are needed.

Light sources, such as LEDs, or multiple LEDs, possibly of different color (e.g., separate red, green and blue LEDs as may be used in a color imaging system), require additional optics to create a uniform light source needed for projectors and microscopy. For example, individual LED dies can be spatially separated. Since the eye is particularly sensitive to color, special provisions are necessary to ensure that the independent colors are mixed at a common target.

Solutions for light mixing, or homogenization that create uniform light sources include lenslet array and light pipe designs. One example of such a system is provided in U.S. Published Patent Application No. 2006/0262282, to Magarilll, addressing the problem of producing uniform light from a LED or multiple LEDs, potentially of different wavelengths using light pipes.

Lenslet array homogenizers are preferred in many applications as they are quite compact and their production is usually accomplished by a molding process, which makes economic sense in large volume production. Unfortunately, lenslet homogenizers typically need to be designed for a specific system, with large initial costs for moulds, and potentially limited homogenization performance compared to other solutions.

Light pipe homogenizer designs tend to be more flexible, allowing a standard product to be used in different Illumination systems. Also, custom hollow light pipes are usually quite inexpensive to obtain even in small quantities. This lends light pipes to be a preferred choice for small to medium volume production due to their low cost, high homogenization and good power efficiency. Additionally, some light pipe homogenizers can out perform lenslet arrays in the task of homogenization. A disadvantage of light pipe homogenizers, however, especially with high-performance homogenization characteristics, is that they are not as compact as lenslet homogenizers. For a light pipe homogenization system, the light pipe alone can be ten times (10×) longer than it is wide. This length does not include the length of other aspects of any realizable system, such as the collecting and condensing optics. Thus, either approach presents challenges as more compact systems are preferred for all the typical reasons, such as cost, weight, portability, etc.

### SUMMARY

Described herein are embodiments of systems and techniques for achieving desirable homogenization and mixing of one or more light sources that can be economically realized within a compact profile. More particularly, the devices and techniques described herein involve the use of diffusers and light pipes in a particular configuration that allows very good homogenization performance while reducing the requisite length of light pipe. For example, by placing a diffuser at a point along a light pipe where the light from each source or each portion of a single source substantially covers the diffuser approximately equally, the rate of homogenization can be increased, thereby reducing the required length of the complete homogenization system. This diffuser position can be after an initial section of light pipe, or potentially in or near collimated space after the source(s).

In one aspect, at least one embodiment described herein provides a compact light homogenizer, including a light pipe extending along an optical axis between two ends. The homogenizer also includes a diffuser positioned along the optical axis and between the two ends.

In some embodiments, the diffuser of the compact light homogenizer is positioned to substantially bisect the light pipe. The diffuser can include a randomized surface structure or an engineered structure to provide tailored diffusion.

In another aspect, at least one embodiment described herein relates to a process for homogenizing illumination from a light source. The process includes coupling into a light pipe, illumination from the light source. The coupled light is mixed along a first length of the light pipe and then diffused. The diffused light is further mixed along a second length of the light pipe. In at least some embodiments, mixing can include total internal reflection.

In yet another aspect, at least one embodiment described herein provides an illumination system, including at least one light source and a light pipe configured to couple illumination from the at least one light source. The light pipe extends along an optical axis between a source end and a target end. The system also includes a diffuser positioned along the optical axis and between the source and target ends. In at least some embodiments, the diffuser can be positioned to substantially bisect the light pipe.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a cross-sectional diagram of an embodiment of a compact light source homogenizer.

FIG. 2 illustrates a cross-sectional diagram of another embodiment of a compact light source homogenizer.

FIG. 3A illustrates a series of illuminations for light pipes of various lengths.

FIG. 3B illustrates a series of illuminations for light pipes of various lengths, each bisected by a respective diffuser.

FIG. 4 illustrates a schematic diagram of an optical system including an embodiment of a compact light source homogenizer.

FIG. 5 illustrates a schematic diagram of an optical system including an embodiment of a compact light source homogenizer.

FIG. 6 illustrates a process for homogenizing illumination from a light source.

### DETAILED DESCRIPTION

A description of embodiments of systems and processes for achieving desirable homogenization and mixing of one or more light sources that can be economically realized within a compact profile follows. More particularly, the devices and techniques described herein involve the use of diffusers and light pipes in a particular configuration that allows very good homogenization performance while reducing the requisite length of light pipe.

The length of a light-pipe homogenizer can be substantially reduced by diffusing the light after it has been partially pre-mixed by a light pipe with a diffuser. For example, by placing a diffuser at a point along a light pipe where the light from each source or each portion of a single source substantially covers the diffuser approximately equally, the rate of homogenization can be increased, thereby reducing the required length of the complete homogenization system. This diffuser position can be after an initial section of light pipe, or potentially in or near collimated space after the source(s). In at least some embodiments, the diffuser can be a low-angle engineered diffuser, followed by additional mixing within a light pipe. In particularly compact solutions of this system a diffuser is sandwiched between two light pipes, or otherwise inserted within a light pipe.

The diffuser boosts the mixing rate, reducing the required light pipe length to achieve a given homogenization level. The diffuser has the largest impact when light from each source illuminates the entire diffuser surface, which occurs in or near collimated space, or after some homogenization has already occurred, such as after a section of light pipe. Diffusing increases the étendue of the system, which typically causes some power loss. (Étendue is generally understood to related to a property of pencils of rays in an optical system, which characterizes how “spread out” light is in area and angle. From the system point of view, the étendue is the area of the entrance pupil times the solid angle the source subtends as seen from the pupil.) It may also be seen as a volume in phase space). Light within the numeric aperture accepted by the following optics is scattered to a higher angle of incidence outside of the accepted numeric aperture. However, by filling the first light pipe with a higher numerical aperture (NA) light than can normally be used by the following system the diffusion process replaces some of the “lost” light, with high NA light scattered down to an accepted NA by the diffuser. Since this entire process happens within a light pipe, the lateral width of the optical system is constrained to a much small dimension than would occur within a typical lensed optical system.

When the modified light pipes described herein are used with a source that has a higher étendue than following optical system, the power loss that normally occurs using a diffuser can be mitigated by recycling normally unused high NA light when it is scattered down to an accepted NA by the diffuser. The homogenization system can work with monochromatic or polychromatic source, single or multiple sources, of differing or similar wavelengths.

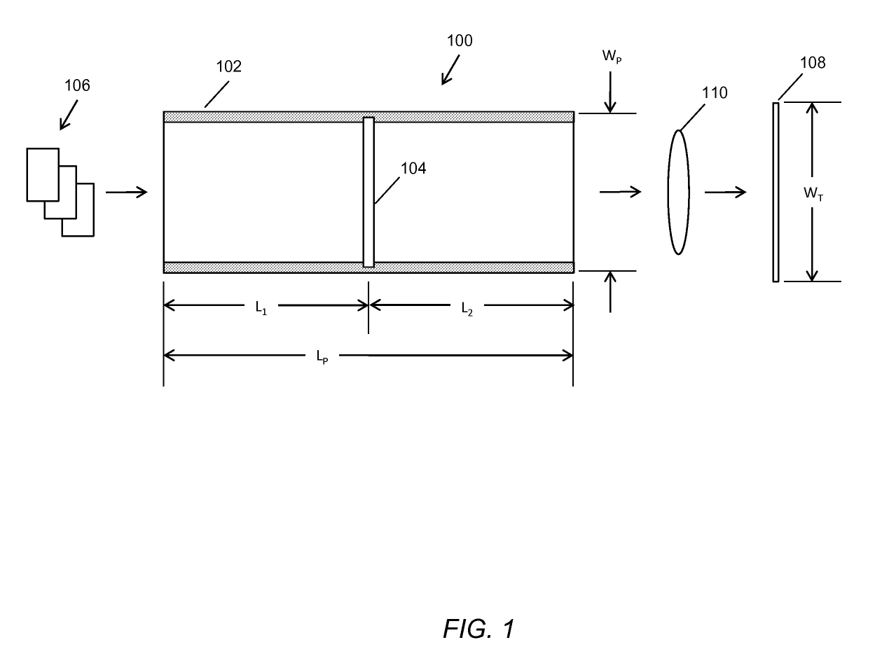

Illustrated in FIG. 1 is a cross section of a modified light pipe 100. The light pipe extends along a longitudinal axis between a light source 106 (shown in this illustrative embodiment as including three distinct light sources, e.g., red, green and blue LEDs) and a target 108 (e.g., a target portion of a user display). The modified light pipe 100 includes a standard light pipe as is generally understood by those skilled in the art, modified to include at least one diffuser 104. As illustrated, the light pipe 102 is a hollow light pipe, with a planar diffuser 104 located at a length L₁ from a source end and a length L₂ from a target end. The overall length of the modified light pipe 100 is L=L₁+L₂.

As illustrated, the diffuser can be retained within a groove or recess within a wall of the light pipe 100. Alternatively or in addition, the diffuser 104 can be retained in position with an adhesive, thermal bonding, welding or with mechanical fasteners or clamps. Although the light pipe 100 is shown as a continuous member, it is also possible that the light pipe include two or more sections, for example, a respective section along either side of the diffuser 104.

Light pipes generally achieve homogenization by total internal reflection for solid pipes and dielectric and/or metallic reflective coatings for hollow pipes. Such light pipe structures can include one or more of hollow structures (pipes) and solid structures (rods). Such structures can be combined with one or more of reflective coatings and dielectric coatings, for example, of differing indexes of refraction. Some examples of light pipes include N-BK7 Light Pipe Homogenizing Rods and TECHSPEC® Tapered Light Pipe Homogenizing Rods, each available from Edmund Optics, Inc. of Barrington N.J.

Diffusers can include precisely shaped holographically recorded randomized surface structures. Such structures can enable one or more of high transmission efficiency, beam shaping and homogenized light output. Some examples of such diffusers are LSD® diffusers commercially available from Luminit Co., of Torrance, Calif. Other diffusers include patterned structures, such as lenslet arrays and other random structures, such as ground glass. Another class of diffusers would be volume scattering materials such as “opal glass”.

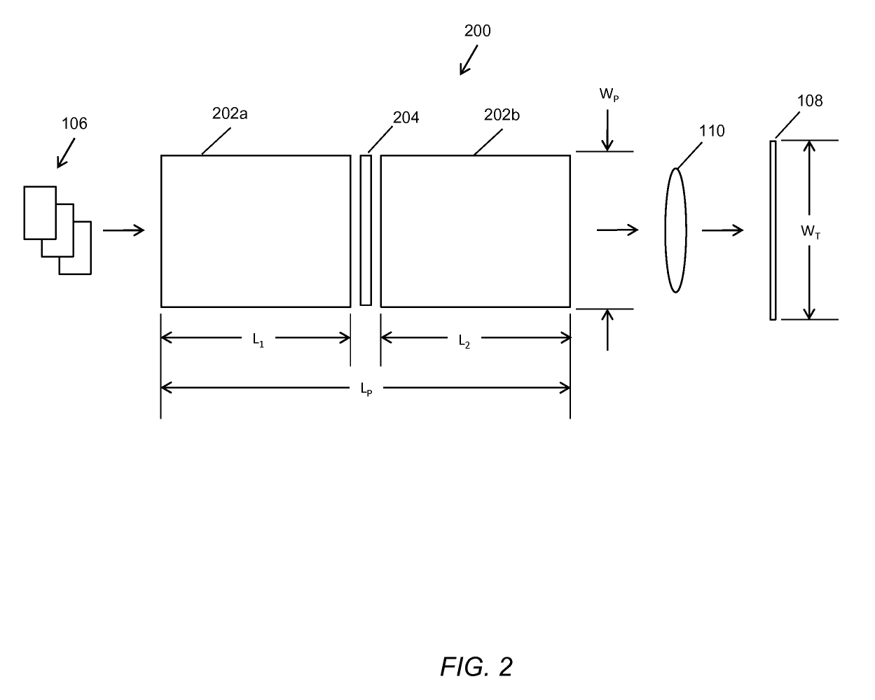

An alternative embodiment of a modified light pipe 200 is illustrated in FIG. 2. In this embodiment, a thin diffuser 204 is located between two solid light pipe segments 202a, 202b. In some embodiments, the diffuser 204 can be bonded between the light pipe segments 202a, 202b. Alternatively or in addition, the diffuser 204 and light pipe segments 202a, 202b can be retained within another housing, frame, or clamping structure (not shown) to retain their arrangement.

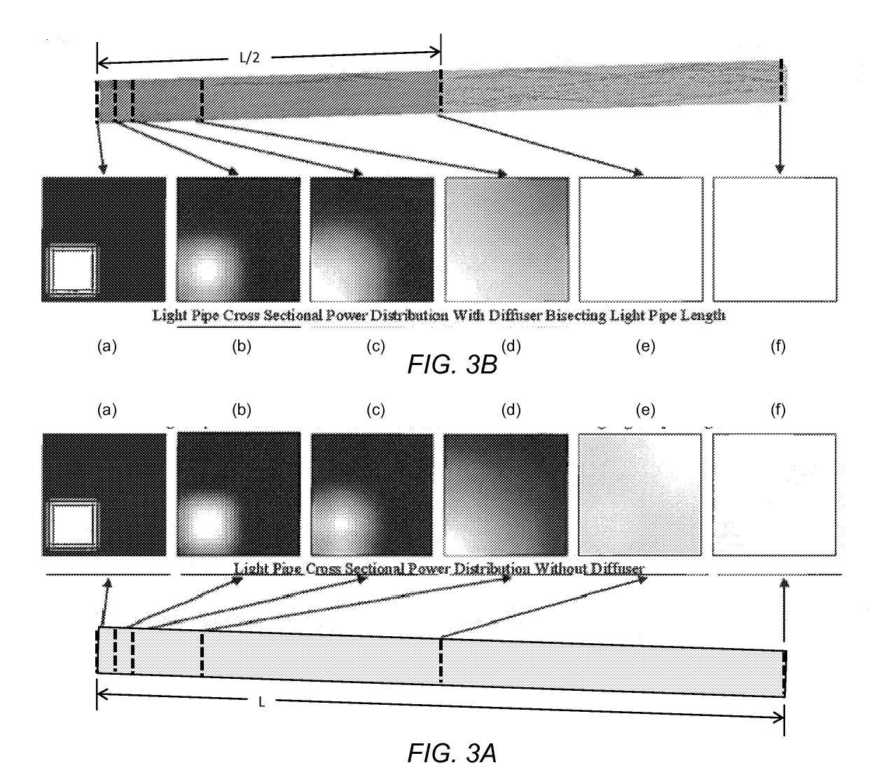

FIG. 3A and 3B show a simple example in which the homogenization capability of a light pipe of various lengths is compared with (FIG. 3B) or without (FIG. 3A) a diffuser bisecting the length of the light pipe. Referring first to FIG. 3A, a light pipe is illustrated as the elongated gray rectangle of length L. Dashed lines along the light pipe are intended to illustrate a similar light pipe of differing lengths ranging from very short (left hand side of the image) to full length (right hand side of the image). Also illustrated above the light pipe are a series of images (a) through (e). Image (a) associated with the shortest light pipe represents a white square on a black field. The white square represents the image (a similar white square) viewed through an extremely short segment of light pipe. Image (b) represents the same source seen through a greater length of light pipe, and so forth, each image representing a respective level of homogenization of the source, until a completely white image is shown in image (f). Image (f) represents a fully homogenized source obtained at light pipe of length L.

Likewise, referring next to FIG. 3B, a light pipe is illustrated as the elongated shaded rectangle of length L. Dashed lines along the light pipe are intended to illustrate a similar light pipe of differing lengths ranging from very short (left hand side of the image) to full length (right hand side of the image). The difference being that for each length of light pipe, the respective light pipe is bisected by a diffuser, such as the diffusers described herein.

Also illustrated below the light pipe are a similar series of images (a) through (f). Associated with the modified light pipe, image (e) represents a fully homogenized source obtained at light pipe of a length substantially less than L. Quite significantly, image (e) was obtained for a light pipe of length L/2, bisected by a diffuser. Thus, full homogenization can be obtained with a modified light pipe that is half the length of an unmodified light pipe. Said differently, a light pipe without a diffuser must be two times longer to achieve the same approximate homogenization performance of a light pipe with a bisecting diffuser half its length.

Although the illustrative example describes modified light pipes having diffusers located substantially at their respective mid sections, it is contemplated that improved performance (i.e., equivalent homogenization at shorter lengths) can be obtained for modified light pipes having a diffuser positioned at different locations along the light pipe's length.

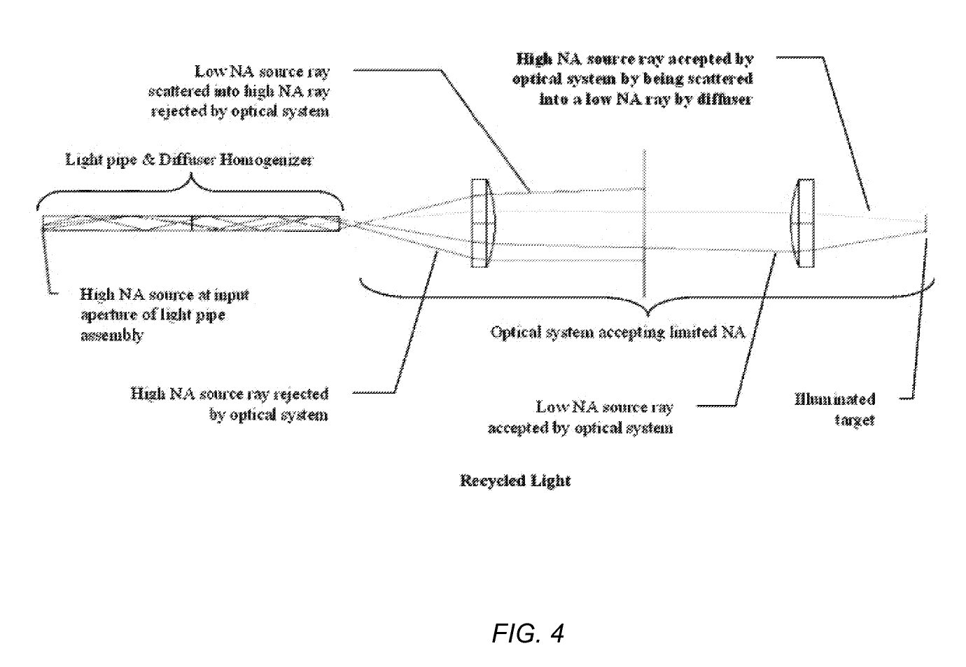

FIG. 4 shows the four types of rays in a system that has a light-pipe accepting light of a larger étendue than what is accepted by the following optical system. In this situation, where the étendue of the following optical system is smaller than the preceding section, some light has to be lost in the process, so that the accepted incoming light has an &endue equal to that of the receiving optics. In this situation, when the homogenization is increased by the use of a diffuser, which raises the étendue, additional light is lost. In this invention, this loss is partially alleviated by recycling light that would normally never be used by a system without a diffuser. In a light pipe homogenizer with equal input and output apertures, the numeric aperture of the light is proportional to the étendue of that light. Light with a high numeric aperture, or high angle of incidence would not normally be accepted by the following optical system. However, some high numeric aperture light scatters off the diffuser into a lower angle of incidence, which can then be accepted by the next optical section. This recycling of light allows a system with a light source with a higher étendue than what is accepted by the following optical system to benefit from the reduced homogenizer sized provided by this invention, with limited power loss normally seen by using a diffuser.

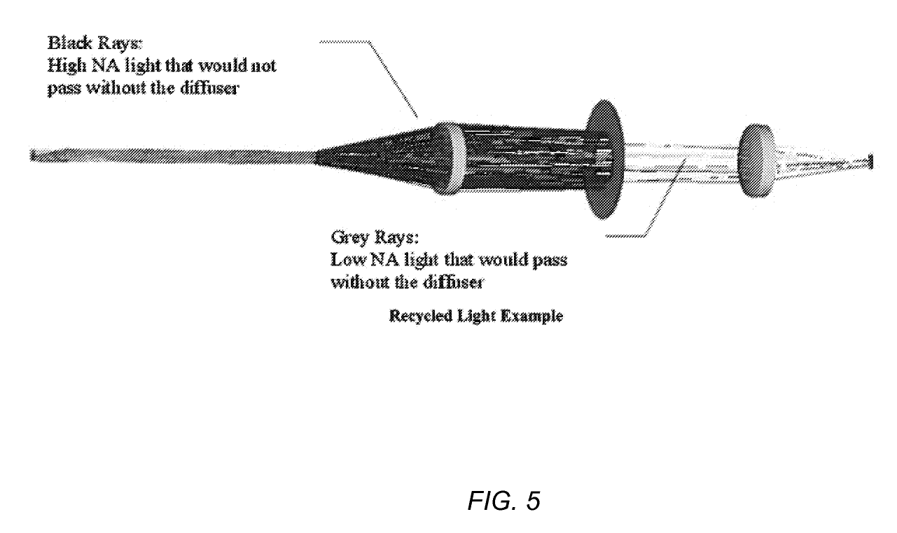

FIG. 5 shows a system with a source with a NA of 0.26 and a following optical system that can accept an NA of 0.2. In this case, the system without a diffuser would couple 55% of the source light. The same system with a diffuser would couple 50% of light. This relatively small power loss is due to the recycling 9% of the higher NA light into a lower usable NA. Without this effect, the diffuser system would have coupled only 41% of the light from the source. In certain situations, such as with very large NA sources, the diffuser system can couple more light than without a diffuser.

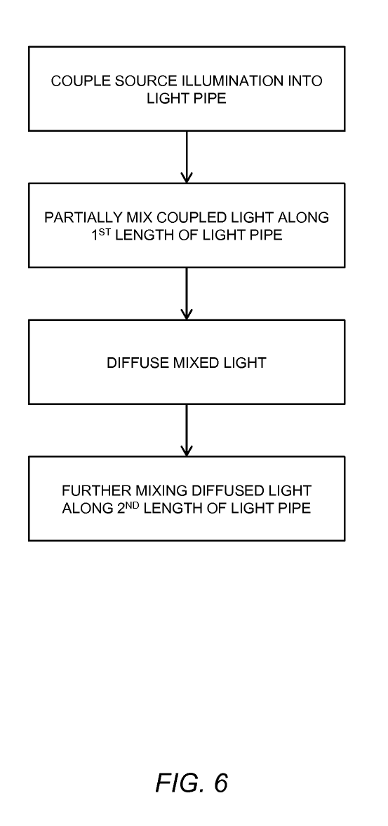

FIG. 6 illustrates an embodiment of a process for homogenizing illumination from a light source. The process includes a first step in which illumination from a light source is coupled into a light pipe. The coupled illumination is partially mixed along a first length of a light pipe. The partially mixed light is then diffused and further mixed along a second length of the light pipe. Light exiting the light pipe is substantially mixed and otherwise homogenized.

Mixing devices or Illuminators are an existing need globally. In addition to display applications, other companies requiring uniformly mixed light from different sources also include the Abbott blood analysis microscope and other medical microscopes for blood analysis. Many additional markets, including projectors, and any other display device requiring the production of uniform light in a short distance can benefit from this technology.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A compact light homogenizer, comprising:
a light pipe extending along an optical axis between two ends; and
a diffuser positioned along the optical axis and between the two ends.

2. The device of claim 1, wherein the light pipe is straight.

3. The device of claim 1, wherein the light pipe is tapered, in at least one cross-sectional axii.

4. The device of claim 1, wherein the light pipe is substantially hollow.

5. The device of claim 1, wherein the light pipe is substantially solid.

6. The device of claim 1, wherein the diffuser comprises a randomized surface structure.

7. The device of claim 1, wherein the diffuser is positioned to substantially bisect the light pipe.

8. A method for homogenizing illumination from a light source, comprising:
coupling into a light pipe, illumination from the light source;
mixing coupled light along a first length of the light pipe;
diffusing the mixed light; and
further mixing the diffused light along a second length of the light pipe.

9. The method of claim 8, wherein mixing comprises total internal reflection.

10. An illumination system, comprising:
at least one light source;
a light pipe configured to couple illumination from the at least one light source, the light pipe extending along an optical axis between a source end and a target end; and
a diffuser positioned along the optical axis and between the source and target ends.

11. The illumination system of claim 10, wherein the diffuser is positioned to substantially bisect the light pipe.

12. The illumination system of claim 10, further comprising at least one optical element positioned between the target end of the light pipe and a display.
